(19) United States
(12) Patent Application Publication
(10) Pub. No.: US 2012/0077039 A1
(43) Pub. Date: Mar. 29, 2012

(54) POLYMER RESIN COMPOSITION, INSULATING FILM MANUFACTURED USING THE POLYMER RESIN COMPOSITION, AND METHOD OF MANUFACTURING THE INSULATING FILM

(75) Inventors: Kyu Sang LEE, Gyeonggi-do (KR); Sang Su Hong, Gyeonggi-do (KR); Hyun Ho Lim, Gyeonggi-do (KR); Hwa Young Lee, Gyeonggi-do (KR); Jae Choon Cho, Gyeonggi-do (KR)

(73) Assignee: SAMSUNG ELECTRO-MECHANICS CO., LTD

(21) Appl. No.: 13/235,040

(22) Filed: Sep. 16, 2011

(30) Foreign Application Priority Data
Sep. 29, 2010 (KR) 10-2010-0094412

(51) Int. Cl. B32B 27/38; B32B 19/00; B28B 1/14

(52) U.S. Cl. 428/413; 264/299; 428/688

(57) ABSTRACT

Provided is a polymer resin composition for manufacturing an insulating film for manufacture of a printed circuit board. The polymer resin composition includes polymer resins and graphene for linking the polymer resins with larger attraction than Van Deer Waals's force of the polymer resins.

### CROSS-REFERENCE TO RELATED APPLICATIONS

This application claims the benefit of Korean Patent Application No. 10-2010-0094412 filed with the Korea Intellectual Property Office on Sep. 29, 2010, the disclosure of which is incorporated herein by reference.

### BACKGROUND OF THE INVENTION

1. Field of the Invention

The present invention relates to a polymer resin composition, an insulating film manufactured using the polymer resin composition, and a method of manufacturing the insulating film, and more particularly, to a polymer resin composition having a small expansion and contraction ratio according to variation in temperature, an insulating film manufactured using the polymer resin composition to reduce a coefficient of thermal expansion (CTE), and a method of manufacturing the insulating film.

2. Description of the Related Art

In general, various kinds of package structures for predetermined electronic devices include printed circuit boards (PCBs). For example, semiconductor integrated circuit chips, various kinds of passive and active devices, and other chip parts may be mounted on the printed circuit board to implement a system package structure.

Since electronic products in recent times are world-widely and universally used, high reliability of the PCB is needed to maintain product reliability under various environments. For example, the PCB having high thermal characteristics and low coefficient of thermal expansion is needed.

More specifically, the PCB is manufactured through a process of laminating a plurality of insulating films, and pressing and plasticizing the laminated films. In this process, due to a difference in coefficient of thermal expansion between a layer plated on a through-hole formed in the PCB and the insulating films, cracks may occur from the plated film. In this case, a short circuit is generated in the PCB to decrease manufacturing efficiency of the PCB.

### SUMMARY OF THE INVENTION

The present invention has been invented in order to overcome the above-described problems and it is, therefore, an object of the present invention to provide a polymer resin composition in which an expansion and contraction ratio according to variation in temperature is reduced.

It is another object of the present invention to provide an insulating film capable of reducing coefficient of thermal expansion of a build-up multi-layered circuit board.

It is still another object of the present invention to provide a method of manufacturing an insulating film capable of reducing a thermal expansion coefficient of a build-up multi-layered circuit board.

In accordance with one aspect of the present invention to achieve the object, there is provided a polymer resin composition includes: polymer resins; and graphene for linking the polymer resins with larger attraction than Van Deer Waals's force of the polymer resins.

In accordance with an embodiment of the present invention, the graphene may be adjusted to 0.05 to 40 wt %.

In accordance with an embodiment of the present invention, the graphene may have a single-layered sheet structure, and may be interposed between the polymer resins.

In accordance with an embodiment of the present invention, the polymer resin composition may further include derivatives formed on a surface of the graphene to increase reactivity between the graphene and solvent having a polarity.

In accordance with an embodiment of the present invention, the polymer resin may use epoxy resin.

In accordance with an embodiment of the present invention, the polymer resin composition may further include a hardener, wherein the hardener uses at least one selected from amines, imidazoles, guanines, acid anhydrides, and polyamines, wherein the hardeners includes at least one selected from 2-methyl imidazole, 2-phenyl imidazole, 2-phenyl-4-phenyl imidazole, bis(2-ethyl-4-methyl imidazole), 2-phenyl-4-methyl-5-hydroxymethyl imidazole, triazine-added imidazole, 2-phenyl-4,5-dihydphoxymethyl imidazole, phthalic acid anhydride, tetrahydrophatalic acid anhydride, methylbuthenyltetrahydrophatalic acid anhydride, hexahydrophatalic acid anhydride, methylhydrophatalic acid anhydride, trimellitic acid anhydride, pyromellitic acid anhydride, and benzophenontetracarboxyl acid anhydride.

In accordance with an embodiment of the present invention, the polymer resin composition may further include a hardening accelerator, wherein the hardening accelerator includes at least one selected from phenol, cyanate ester, amine, and imidazole.

In accordance with an embodiment of the present invention, the polymer resin composition may further include a filler, wherein the filler includes at least one selected from barium sulfate, barium titanate, silicon oxide powder, amorphous silica, talc, clay, and mica powder.

In accordance with an embodiment of the present invention, the polymer resin composition may further include a reactive thinner, wherein the reactive thinner includes at least one selected from phenyl glycidyl ether, resorcin diglycidyl ether, ethylene glycoldiglycidyl ether, glycerol triglycidyl ether, resol novolac type phenol resin, and isocyanate compound.

In accordance with an embodiment of the present invention, the polymer resin composition may further include a binder, wherein the binder includes at least one selected from polyacryl resin, polyamide resin, polyamideimide resin, polycyanate resin, and polyester resin.

In accordance with another aspect of the present invention to achieve the object, there is provided an insulating film for manufacturing a printed circuit board manufactured of a polymer resin composition including polymer resins and graphene for linking the polymer resins with larger attraction than Van Deer Waals's force of the polymer resins.

In accordance with an embodiment of the present invention, the graphene may be adjusted to 0.05 to 40 wt % with respect to the polymer resin composition.

In accordance with an embodiment of the present invention, the polymer resin may include epoxy resin.

In accordance with still another aspect of the present invention to achieve the object, there is provided a method of manufacturing an insulating film for manufacture of a printed circuit board, which includes: preparing a mixture by mixing polymer resins and graphene for linking the polymer resins with larger attraction than Van Deer Waals's force of the polymer resins; mixing and dispersing the mixture to form polymer resin composition; and casting the polymer resin composition to make a film.

In accordance with an embodiment of the present invention, preparing the mixture may include adjusting a content of the graphene such that the content of the graphene becomes 0.05 to 40 wt % with respect to the polymer resin composition.

In accordance with an embodiment of the present invention, the polymer resin may use epoxy resin.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a view showing a polymer resin composition in accordance with an exemplary embodiment of the present invention; and

FIG. 2 is a view for explaining characteristics of the polymer resin composition in accordance with an exemplary embodiment of the present invention.

### DETAILED DESCRIPTION OF THE PREFERABLE EMBODIMENTS

Hereinafter, embodiments of the present invention will be described in detail with reference to the accompanying drawings. The following embodiments are provided as examples to fully convey the spirit of the invention to those skilled in the art. Therefore, the present invention should not be construed as limited to the embodiments set forth herein and may be embodied in different forms. And, the size and the thickness of an apparatus may be overdrawn in the drawings for the convenience of explanation. The same components are represented by the same reference numerals hereinafter.

The terms used throughout this specification are provided to describe embodiments but not intended to limit the present invention. In this specification, a singular form includes a plural form unless the context specifically mentions. When an element is referred to as “comprises” and/or “comprising”, it does not preclude another component, step, operation and/or device, but may further include the other component, step, operation and/or device unless the context clearly indicates otherwise.

Hereinafter, a polymer resin composition, an insulating film manufactured using the polymer resin component, and a method of manufacturing the insulating film in accordance with an exemplary embodiment of the present invention will be described in detail.

The polymer resin composition in accordance with an exemplary embodiment of the present invention may include a polymer resin, a hardener, a hardening accelerator, and a graphene.

The polymer resin may include epoxy resin. The epoxy resin may be an insulating material used as an interlayer insulating material of a build-up multi-layered circuit board upon manufacture thereof. For this, the epoxy resin may have good thermal resistance, chemical resistance and electrical characteristics. For example, the epoxy resin may include at least one heterocyclic epoxy resin selected from bisphenol A-type epoxy resin, bisphenol F-type epoxy resin, phenol novolac epoxy resin, dicyclopentadiene-type epoxy resin, and triglycidyl isocyanate. In addition, the epoxy resin may include bromine-substituted epoxy resin.

The hardener may use various hardeners according to kinds of epoxy resins as described above. For example, the hardener may include at least one selected from amines, imidazoles, guanines, acid anhydrides, and polyamines. In addition, the hardeners may include at least one selected from 2-methyl imidazole, 2-phenyl imidazole, 2-phenyl-4-phenyl imidazole, bis(2-ethyl-4-methyl imidazole), 2-phenyl-4-methyl-5-hydroxymethyl imidazole, triazine-added imidazole, 2-phenyl-4,5-dihydphoxymethyl imidazole, phthalic acid anhydride, tetrahydrophatalic acid anhydride, methylbuthenyltetrahydrophatalic acid anhydride, hexahydrophatalic acid anhydride, methylhydrophatalic acid anhydride, trimellitic acid anhydride, pyromellitic acid anhydride, and benzophenontetracarboxyl acid anhydride.

The hardening accelerator may include at least one selected from phenol, cyanate ester, amine, and imidazole.

The graphene is a carbon nano material that can act as a bridge between the epoxy resins in the polymer resin composition. For example, the graphene has high electron cloud density, and thus, the epoxy resins may be linked with strong attraction. At this time, the attraction of the epoxy resin provided by the graphene may be very strong in comparison with Van Der Waals' force of the epoxy resin. Accordingly, due to the graphene, the polymer resin composition may have very low expansion and contraction ratio with respect to variation in temperature.

The graphene may be added to the polymer resin composition at substantially 0.05 to 40 wt %. When the content of the graphene is less than 0.05 wt %, since the content of the graphene is relatively low, it may be difficult to obtain an effect of the graphene that links the epoxy resins with strong attraction. On the other hand, when the content of the graphene is more than 40 wt %, excessive addition of the graphene may cause decrease in insulating characteristics of the polymer resin composition and relative reduction in content of other materials may cause decrease in material characteristics.

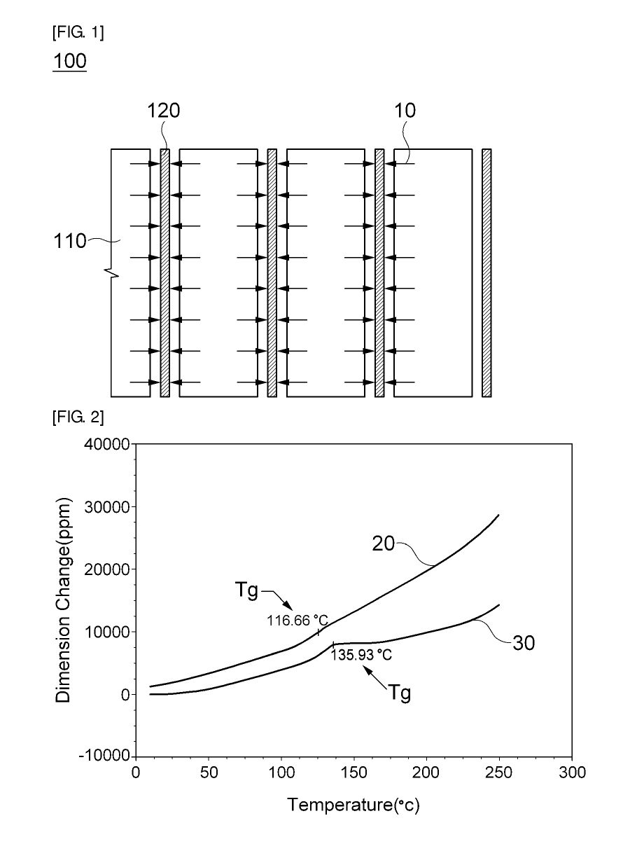

The effect and theory of the graphene as described above will be described with reference to the accompanying drawings. FIG. 1 shows a polymer resin composition in accordance with an exemplary embodiment of the present invention. Referring to FIG. 1, the polymer resin composition 100 includes epoxy resins 110 and graphene 120. The graphene 120 is a single-layered sheet structure, which may be interposed between the epoxy resins 110. In this case, since the graphene 120 provides strong attraction 10 to both of the epoxy resins 110, the attraction 10 between the epoxy resins 110 can be maximized. In order to form the sheet structure of carbon nano material, the graphene 120 having a general single-layered structure may be most appropriate. If a hexagonal honeycomb structure or a multi-layered structure such as carbon nano tube is provided, since there is no effect of providing attraction to both sides like the graphene 120, the epoxy resins 110 may not be linked with strong attraction. In addition, since the carbon nano tube itself has lower attraction than that of the graphene 120, it is difficult to expect the high bridge effect similar to that of the graphene 120.

Here, since the graphene 120 itself has a very large polarity, the graphene may not be easily dispersed in solvent having strong polarity. Accordingly, since the graphene 120 cannot be easily added to the polymer resin composition, in order to easily dissolve the graphene 120 by the solvent, derivatives may be chemically bonded to the surface of the graphene 120 to be used. For example, derivatives such as a carboxyl group, an alkyl group, and amine group may be formed to increase solubility of the graphene 122b to the solvent.

Meanwhile, the polymer resin composition may further include predetermined additives. The additives may be provided to improve manufacturing characteristics and board characteristics, when the insulating film is manufactured using the polymer resin composition and further when the multi-layered circuit board using the insulating film. For example, the additives may include filler, reactive thinner, binder, and so on.

The filler may use inorganic or organic filler. For example, the filler may include at least one selected from barium sulfate, barium titanate, silicon oxide powder, amorphous silica, talc, clay, and mica powder. An additive content of the filler may be adjusted to about 1 to 30 wt % with respect to the total weight of the polymer resin composition. When the additive amount of the additive is less than 1 wt %, it may be difficult to perform a function of the filler. On the contrary, when the additive amount of the additive is more than 30 wt %, electrical characteristics such as permittivity of a product formed of the polymer resin composition may be decreased.

The reactive thinner may be a material for adjusting viscosity of the polymer resin composition upon manufacture thereof to smoothly perform the manufacture thereof. The reactive thinner may include at least one selected from phenyl glycidyl ether, resorcin diglycidyl ether, ethylene glycoldiglycidyl ether, glycerol triglycidyl ether, resol novolac type phenol resin, and isocyanate compound.

The binder may be provided to improve flexibility of the insulating film manufactured of the polymer resin composition, or improve material characteristics. The binder may include at least one selected from polyacryl resin, polyamide resin, polyamideimide resin, polycyanate resin, and polyester resin.

The reactive thinner and the binder may be added to the polymer resin composition to 30 wt % or less. If the content of the reactive thinner and the binder is more than 30 wt % with respect to the polymer resin composition, material characteristics of the polymer resin composition may be decreased, and thus, electrical, mechanical and chemical characteristics of the product manufactured of the polymer resin composition may also be decreased.

In addition, the polymer resin composition may further include a predetermined rubber as the additives. For example, after pre-curing the insulating film laminated in an internal circuit, a wet conditioning process is performed using an oxidizer to improve adhesion with the plated layer. Accordingly, a rubber or epoxy-modified rubber resin, which is soluble to the oxidizer, may be used as a harmonic component (rubber) to the insulating film composition. An example of the used rubber is not limited thereto but may include at least one selected from polybutadiene rubber, epoxy-modified, acrylonitrile-modified, and urethane-modified polybutadiene rubber, acrylonitrile butadiene rubber, acryl rubber-dispersed epoxy resin. The harmonic component may be adjusted to about 5 to 30 wt % with respect to the polymer resin composition. When the harmonic component is less than 5 wt %, the harmony may be decreased. On the other hand, when the harmonic component is more than 30 wt %, mechanical strength of a product manufactured of the polymer resin composition may be decreased.

FIG. 2 is a graph for explaining characteristics of the polymer resin composition for manufacturing a circuit board in accordance with an exemplary embodiment of the present invention. FIG. 2 is a graph showing thermal characteristics of the polymer resin composition, an x-axis represents a temperature, and a y-axis represents a dimension change according to variation in temperature of the composition resin composition. Reference numeral 30 represents thermal characteristics test results of the polymer resin composition 30 in accordance with an exemplary embodiment of the present invention, and reference numeral 20 shows thermal characteristics rest results of a comparative polymer resin composition 20 used as a comparative example of the polymer resin composition 30. The comparative polymer resin composition 20 is distinguished from the polymer resin composition 30 in that the graphene is not added.

Referring to FIG. 2, it will be appreciated that the polymer resin composition 30 in accordance with an exemplary embodiment of the present invention has a lower coefficient of thermal expansion (CTE) than that of the comparative polymer resin composition 20 in which the graphene is selectively removed from the polymer resin composition 30. In particular, it has been confirmed that the polymer resin composition 30 of the present invention has a remarkably lower coefficient of thermal expansion than that of the comparative polymer resin composition 20. Accordingly, the polymer resin composition 30 in accordance with an exemplary embodiment of the present invention has little thermal expansion even at a temperature range for a general surface mount technology (SMT) of the printed circuit board (for example, about 250□ to 280□). As a result, the PCB manufactured of the polymer resin composition 30 can remarkably decrease the coefficient of thermal expansion to make it possible to prevent occurrence of cracks of a circuit pattern generated due to a difference in coefficient of thermal expansion between the circuit pattern and the insulating film during a manufacturing process.

The test results of the polymer resin composition 30 will be summarized as the following Table 1.

TABLE 1

| Characteristics | Comparative Example (20) | Test Example (30) |
|---|---|---|
| Glass Transition | 116.66 | 135.93 |
| Temperature (Tg)(□) | | |

Coefficient of Thermal Expansion (CTE)

| | | | |
|---|---|---|---|
| (ppm/□) | α1 | 70.27 | 59.90 |
| | α2 | 142.20 | 53.55 |

In Table 1, α1 means represents a temperature range lower than the glass transition temperature Tg, and α2 represents a temperature range higher than the glass transition temperature Tg. As shown in Table 1, it will be appreciated that the polymer resin composition in accordance with an exemplary embodiment of the present invention has a lower coefficient of thermal expansion according to variation in temperature than that of the comparative polymer resin composition in which the graphene is not added. In particular, it will be appreciated that the polymer resin composition in accordance with the present invention remarkably decreases the coefficient of thermal expansion at a temperature range of α2. Accordingly, when the build-up multi-layered PCB is manufactured of the polymer resin composition in accordance with an exemplary embodiment of the present invention, the coefficient of thermal expansion of the build-up insulating film can be reduced to prevent occurrence of cracks in the plated film due to a difference in coefficient of thermal expansion.

As can be seen from the foregoing, a polymer resin composition in accordance with the present invention may include a graphene to link polymer resins using attraction larger than Van Deer Waals' force between the polymer resins. Accordingly, the polymer resin composition in accordance with the present invention can reduce an expansion and contraction ratio according to variation in temperature to be used as a composition for manufacturing a build-up multi-layered circuit board having a low coefficient of thermal expansion.

An insulating film for manufacturing a circuit board in accordance with the present invention may be formed of a polymer resin composition including a graphene to link polymer resins using attraction larger than Van Deer Waals' force between the polymer resins. Accordingly, the insulating film in accordance with the present invention can reduce an expansion and contraction ratio according to variation in temperature to be used as an insulating film for manufacturing a build-up multi-layered circuit board capable of reducing a low coefficient of thermal expansion.

A method of manufacturing an insulating film for manufacturing a circuit board in accordance with the present invention may manufacture an insulating film using the polymer resin composition including a graphene to link polymer resins using attraction larger than Van Deer Waals' force between the polymer resins. Accordingly, the method of manufacturing an insulating film in accordance with the present invention can reduce an expansion and contraction ratio according to variation in temperature to be used as an insulating film for manufacturing a circuit board capable of reducing a low coefficient of thermal expansion.

This invention may be embodied in different forms and should not be construed as limited to the embodiments set forth herein. Rather, these embodiments are provided so that this disclosure will be thorough and complete, and will fully convey the scope of the invention to those skilled in the art. As described above, although the preferable embodiments of the present invention have been shown and described, it will be appreciated by those skilled in the art that substitutions, modifications and variations may be made in these embodiments without departing from the principles and spirit of the general inventive concept, the scope of which is defined in the appended claims and their equivalents.

What is claimed is:

1. A polymer resin composition for manufacturing an insulating film for manufacture of a build-up multi-layered printed circuit board, which comprises:
polymer resins; and
graphene for linking the polymer resins with larger attraction than Van Deer Waals's force of the polymer resins.

2. The polymer resin composition according to claim 1, wherein the graphene is adjusted to 0.05 to 40 wt %.

3. The polymer resin composition according to claim 1, wherein the graphene has a single-layered sheet structure, and is interposed between the polymer resins.

4. The polymer resin composition according to claim 1, further comprising derivatives formed on a surface of the graphene to increase reactivity between the graphene and solvent having a polarity.

5. The polymer resin composition according to claim 1, wherein the polymer resin uses epoxy resin.

6. The polymer resin composition according to claim 1, further comprising a hardener, wherein the hardener uses at least one selected from amines, imidazoles, guanines, acid anhydrides, and polyamines, wherein the hardeners comprises at least one selected from 2-methyl imidazole, 2-phenyl imidazole, 2-phenyl-4-phenyl imidazole, bis(2-ethyl-4-methyl imidazole), 2-phenyl-4-methyl-5-hydroxymethyl imidazole, triazine-added imidazole, 2-phenyl-4,5-dihydphoxymethyl imidazole, phthalic acid anhydride, tetrahydrophatalic acid anhydride, methylbuthenyltetrahydrophatalic acid anhydride, hexahydrophatalic acid anhydride, methylhydrophatalic acid anhydride, trimellitic acid anhydride, pyromellitic acid anhydride, and benzophenontetracarboxyl acid anhydride.

7. The polymer resin composition according to claim 1, further comprising a hardening accelerator, wherein the hardening accelerator comprises at least one selected from phenol, cyanate ester, amine, and imidazole.

8. The polymer resin composition according to claim 1, further comprising a filler, wherein the filler comprises at least one selected from barium sulfate, barium titanate, silicon oxide powder, amorphous silica, talc, clay, and mica powder.

9. The polymer resin composition according to claim 1, further comprising a reactive thinner, wherein the reactive thinner comprises at least one selected from phenyl glycidyl ether, resorcin diglycidyl ether, ethylene glycoldiglycidyl ether, glycerol triglycidyl ether, resol novolac type phenol resin, and isocyanate compound.

10. The polymer resin composition according to claim 1, further comprising a binder, wherein the binder comprises at least one selected from polyacryl resin, polyamide resin, polyamideimide resin, polycyanate resin, and polyester resin.

11. An insulating film for manufacturing a printed circuit board manufactured of a polymer resin composition comprising polymer resins and graphene for linking the polymer resins with larger attraction than Van Deer Waals's force of the polymer resins.

12. The insulating film for manufacturing a printed circuit board according to claim 11, wherein the graphene is adjusted to 0.05 to 40 wt % with respect to the polymer resin composition.

13. The insulating film for manufacturing a printed circuit board according to claim 11, wherein the polymer resin comprises epoxy resin.

14. A method of manufacturing an insulating film for manufacture of a printed circuit board, which comprises:
preparing a mixture by mixing polymer resins and graphene for linking the polymer resins with larger attraction than Van Deer Waals's force of the polymer resins;
mixing and dispersing the mixture to form polymer resin composition; and
casting the polymer resin composition to make a film.

15. The method of manufacturing an insulating film for manufacture of a printed circuit board according to claim 14, wherein preparing the mixture comprises adjusting a content of the graphene such that the content of the graphene becomes 0.05 to 40 wt % with respect to the polymer resin composition.

16. The method of manufacturing an insulating film for manufacture of a printed circuit board according to claim 14, wherein the polymer resin uses epoxy resin.
